(19) United States
(12) Patent Application Publication
(10) Pub. No.: US 2024/0001297 A1
(43) Pub. Date: Jan. 4, 2024

(54) METHODS AND SYSTEMS FOR CONTROLLING CONDENSATE WHEN REDUCING OXYGEN CONTENT IN BIOGAS

(71) Applicant: MONTAUK ENERGY HOLDINGS, LLC, Pittsburgh, PA (US)

(72) Inventor: JEAN-PIERRE MICHAEL ALLERA, PITTSBURGH, PA (US)

(73) Assignee: MONTAUK ENERGY HOLDINGS, LLC, Pittsburgh, PA (US)

(21) Appl. No.: 18/216,022

(22) Filed: Jun. 29, 2023

Related U.S. Application Data
(60) Provisional application No. 63/356,707, filed on Jun. 29, 2022.

(51) Int. Cl. B01D 53/78; B01D 53/14; B01D 53/68

(52) U.S. Cl. CPC B01D 53/78; B01D 53/1493; B01D 53/1456; B01D 53/68; B01D 2252/103; B01D 2251/304; B01D 2251/604; B01D 2257/2045; B01D 2257/2047; B01D 2258/05

(57) ABSTRACT

A method of neutralizing condensate from a gas flow subject to a combustion oxygen removal process passing through a number of cooling steps post combustion includes: providing a supply of water to the gas flow prior to a particular cooling step of the number of cooling steps; collecting an aqueous condensate solution from the gas flow prior to the particular cooling step; and providing a supply of a neutralizing agent to the aqueous condensate solution.

### CROSS REFERENCE TO RELATED APPLICATIONS

This application claims priority to U.S. Provisional Patent Application Ser. No. 63/356,707, filed Jun. 29, 2022, titled “Combustion Based Oxygen Removal Condensate Neutralization”, the contents of which are incorporated by reference herein.

### FIELD OF THE INVENTION

The disclosed concept relates generally to methods and systems for reducing oxygen content in biogas and, more particularly to methods and systems for controlling condensate when reducing oxygen content in biogas.

### BACKGROUND OF THE INVENTION

Biogas, whose primary component is methane, is naturally produced from the decomposition of organic waste. Common sources of biogas include landfills, manure from dairy and swine farms, and wastewater treatment facilities. Biogas can be collected and processed for use as renewable natural gas, electricity, or boiler heat. Companies in the biogas industry capture biogas and either convert it into pipeline-quality renewable natural gas which is injected it into a pipeline, or utilize the biogas for the generation of electricity.

In recent years, gas utilities have required that gas sold into their pipelines meet reduced Oxygen levels (down to the ppm level). This has required the facilities built with these specifications in mind to include Oxygen removal (previously not included) as a now crucial component of the processing facility. Oxygen is typically removed via combustion. This combustion occurs in a reaction vessel at elevated temperatures in the presence of a heavy metal catalyst. See below for the combustion reaction.

2O₂+CH₄→CO₂+2H₂O

While such combustion reaction eliminates the Oxygen, the reaction in turn creates a proportional amount of water, which thus must be removed to meet the water requirements for the gas utility and potentially for gas compression or other processing equipment. Water is first removed via chilling and then by a typical dryer unit for the remainder. The chilling is designed to minimize the load on the dryer unit. At the end of this process, a gaseous stream that is now sufficiently lean on both Oxygen and water can move onward within the processing facility. A flow chart showing the general steps of one example of such combustion-based oxygen removal is shown in FIG. 1.

A problem with the process described above occurs wherein the locations associated with the water condensate removal from the gas stream are damaged. As shown in the flow-chart of FIG. 2, such locations include the cooling components, dryer unit, and condensation collection. As the cost and time to repair/replace such components is extensive, such damage presents a major problem.

### SUMMARY OF THE INVENTION

Such problem discussed above, and others, are met by embodiments of the disclosed concept. As an aspect of the disclosed concept, a method of neutralizing condensate from a gas flow subject to a combustion oxygen removal process passing through a number of cooling steps post combustion is provided. The method comprises: providing a supply of water to the gas flow prior to a particular cooling step of the number of cooling steps; collecting an aqueous condensate solution from the gas flow prior to the particular cooling step; and providing a supply of a neutralizing agent to the aqueous condensate solution.

Providing the supply of the neutralizing agent to the aqueous condensate solution may comprise providing a supply of an aqueous neutralizing agent.

The number of cooling steps may comprise a plurality of cooling steps in series, and wherein the method may further comprise, prior to providing the supply of water to the gas flow, determining as the particular cooling step a cooling step among the plurality of colling steps in which liquid condensate occurs from the gas flow.

Determining the cooling step in which liquid condensate occurs from the gas flow may comprise: determining the temperature achieved at the different points along the plurality of cooling steps as well as a vapor pressure of the water associated with the temperatures at each point; determining a partial pressure of the water in gaseous phase post reaction using inlet water concentration in addition to the stoichiometric amount of water created from the combustion of the oxygen present with the methane and using the thermodynamic properties of the system and determining a location where the vapor pressure of the water becomes equal to the partial pressure of the water.

Providing the supply of water to the gas flow prior to the particular cooling step may comprise providing a continuous supply of water to the gas flow via an inserted atomizing lance.

Providing the supply of water to the gas flow prior to the particular cooling step may comprise providing the supply of water within process piping carrying the gas flow, and collecting the aqueous condensate solution from the gas flow prior to the particular cooling step comprises collecting the aqueous condensate solution from the process piping.

Providing the supply of water to the gas flow prior to the particular cooling step may comprise providing the supply of water within a gas-liquid contact tower, and collecting the aqueous condensate solution from the gas flow prior to the particular cooling step may comprise collecting the aqueous condensate solution from the contact tower.

Providing the supply of the aqueous neutralizing agent may comprise providing the aqueous neutralizing agent via an inserted atomizing lance.

The neutralizing agent may be a NaOH solution.

The method may further comprise communicating a remaining gas flow from the gas flow after providing the supply of water to the particular cooling step.

The particular cooling step may comprise one of: a gas-gas economizing exchanger, an air-cooling heat exchanger, or a refrigeration-based cooling heat exchanger.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

A full understanding of the disclosed concept can be gained from the following description of the preferred embodiments when read in conjunction with the accompanying drawings in which:

FIG. 1 is a flow chart showing the general steps of a non-limiting example of a conventional combustion-based oxygen removal process;

FIG. 2 is a flow chart similar to that of FIG. 1 but further indicating steps/components therein subject to damage from such conventional combustion-based oxygen removal process;

FIG. 3 is a flow chart showing the general steps of a combustion-based oxygen removal process showing steps/components therein in accordance with an example embodiment of the disclosed concept; and

FIG. 4 is a flow chart of a portion of the process of FIG. 3 employing a gas liquid contact tower in accordance with an example embodiment of the disclosed concept.

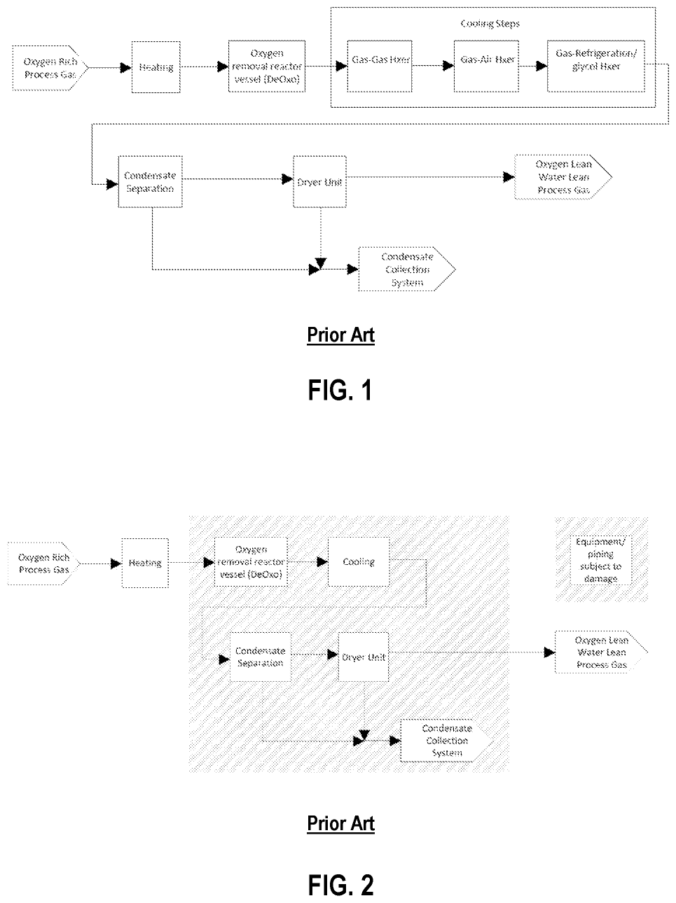

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, quantity of components used, embodiment configurations and other physical characteristics related to the embodiments disclosed herein are not to be considered limiting on the scope of the disclosed concept.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

Assessment of the damage to systems such as described in the Background section above associated condensate with the damage and initial assessments were done on such condensate. The condensate was found to be very acidic but varying (from pH of 0.5 to 4.5) from facility to facility seeing such issue. Chemical element analysis showed halogens (fluorine/chlorine/etc.) in the condensate, suggesting a hydrofluoric acid and a hydrochloric acid, and demonstrating a mix of strong and weak acids. Gaseous analysis (taken prior to the Oxygen removal) showed a potential source of these halogens prior to acid generation to be ppm levels of refrigerants (Chloroflorocarbons—CFCs) in the source gas from the landfill. In just a few months, this acidity can create hundreds of thousands of dollars in costs due to damage to components like heat exchangers, piping, and instruments, as well as lost production due to downtime while troubleshooting and replacing components.

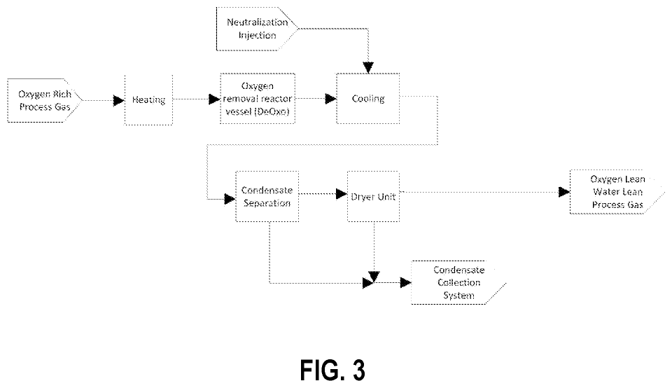

After determining the general cause of the damage, the goal became to neutralize the acid to protect the equipment and keep the processing facility operational. Through quantitative analysis of the pressure, temperature, and Oxygen/water profiles, several conclusions could be drawn on contributing factors associated with the damage witnessed. While the acid appeared to be generated within the reactor vessel, damage to the equipment did not appear to occur without the presence of liquid water. The aim then became to control the point at which the acid transitions from its gaseous phase to its harmful aqueous phase. Referring to FIG. 3, by injecting an amount of a neutralizing agent during cooling of the gas to neutralize the acid in addition to an amount of water to ensure that water was present in liquid form at the point of injection (so the acid would be aqueous rather than gaseous), one can reduce exposure of equipment to an undesirable pH condensate. Testing of this approach has shown success by extending equipment longevity and a condensate of a more neutral pH entering the collection system.

A typical cooling step includes a combination, or all, of an economizing heat exchanger (gas-gas exchanger that transfers heat exiting the hot reactor to the gas heating up to enter it), a fan cooler (to cool the gas close to near ambient temperatures), and a final cooling exchanger on a refrigeration loop (to cool to below ambient temperatures). Each of these heat exchangers will have a predictable inlet and outlet temperature for the process gas. To protect all the equipment, one would model and determine which cooling step would first facilitate water condensing from the gaseous to the liquid phase under the condition with the highest possible inlet Oxygen, lowest temperatures, and highest pressure (per the processing facility's operating conditions). The introduction of water and neutralizing agent would then be located just upstream of this piece of cooling equipment.

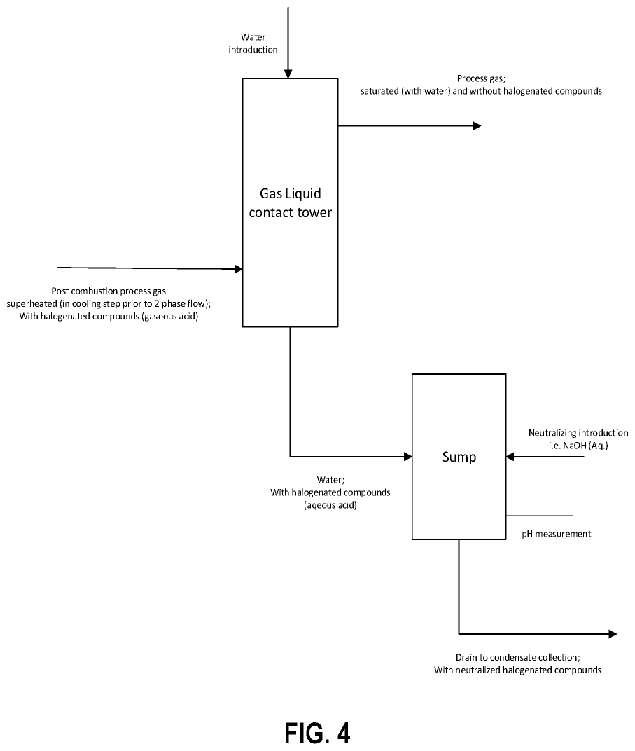

Once the introduction point is established, the next step is determining the required mass flowrate of the liquid water. The required flowrate for this application is expressed as a flow rate that would correspond to the difference between the vapor pressure of water at the point of introduction, determined by thermodynamic properties, and the partial pressure of water, determined stoichiometrically from the combustion of the inlet oxygen, plus an additional amount for redundancy. This amount of water can be injected via a pump into the process piping continuously through an inserted atomizing lance. As an alternative to injecting directly into the process piping, a gas-liquid contacting vessel can instead be utilized, such as shown in FIG. 4.

With water introduced as described, one would be creating and controlling the first point where liquid water would be present (i.e., the condensation point) and therefore the point where the acid transitions from its gaseous phase to its harmful aqueous phase. If a contacting vessel is employed, the liquid outlet of the vessel will contain the undesired aqueous halogenated compounds (acid) and said compounds would never be exposed to downstream process gas equipment.

If the amount of water required for injection is impractical for the processing facility, then the water could be introduced downstream of the initial determined point where the gas is at a lower temperature. This will result in a lower water demand but leaving a defined amount of equipment still subject to damage by the generated acid (such approach may potentially be justified with a cost-benefit analysis).

With the acid becoming aqueous at a controlled location, an aqueous neutralizing agent should be introduced at the same injection location or immediately downstream of the water introduction. This can be introduced via a pump into the process piping continuously through an inserted atomizing lance, or into the liquid outlet of a contact tower. This aqueous neutralizing agent should be introduced in a sufficient amount to bring the condensate to a neutral pH. This amount can be determined by a field titration of an acidic condensate sample. pH monitoring should occur regularly, if not continuously, so adjustments could be made to the amount of neutralizing agent injected. Note this amount will vary with the flow from the plants source (landfill, digestor, etc.). The neutralizing agent can be a strong base like sodium hydroxide, a weak base, or a buffered weak acid (buffered phosphoric II for example). The above examples are options listed from simplest (and cheapest) to most complex to initially set up as well as from least to most resilient to process swings respectively. Note, neutralizing agents should be selected that have a much higher affinity for their aqueous phase than their vapor phase to avoid interfering with the process gas downstream of the injection. In example embodiments of the disclosed concept, NaOH (aq) and buffered phosphoric acid solutions have been employed as neutralizing agents however, it is to be appreciated that other neutralizing agents may be employed without varying from the scope of the disclosed concept.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A method of neutralizing condensate from a gas flow subject to a combustion oxygen removal process passing through a number of cooling steps post combustion, the method comprising:
providing a supply of water to the gas flow prior to a particular cooling step of the number of cooling steps;
collecting an aqueous condensate solution from the gas flow prior to the particular cooling step; and
providing a supply of a neutralizing agent to the aqueous condensate solution.

2. The method of claim 1, wherein providing the supply of the neutralizing agent to the aqueous condensate solution comprises providing a supply of an aqueous neutralizing agent.

3. The method of claim 1, wherein the number of cooling steps comprises a plurality of cooling steps in series, and wherein the method further comprises, prior to providing the supply of water to the gas flow, determining as the particular cooling step a cooling step among the plurality of colling steps in which liquid condensate occurs from the gas flow.

4. The method of claim 3, wherein determining the cooling step in which liquid condensate occurs from the gas flow comprises:
determining the temperature achieved at the different points along the plurality of cooling steps as well as a vapor pressure of the water associated with the temperatures at each point;
determining a partial pressure of the water in gaseous phase post reaction using inlet water concentration in addition to the stoichiometric amount of water created from the combustion of the oxygen present with the methane and using the thermodynamic properties of the system and
determining a location where the vapor pressure of the water becomes equal to the partial pressure of the water.

5. The method of claim 1, wherein providing the supply of water to the gas flow prior to the particular cooling step comprises providing a continuous supply of water to the gas flow via an inserted atomizing lance.

6. The method of claim 1, wherein:
providing the supply of water to the gas flow prior to the particular cooling step comprises providing the supply of water within process piping carrying the gas flow, and
collecting the aqueous condensate solution from the gas flow prior to the particular cooling step comprises collecting the aqueous condensate solution from the process piping.

7. The method of claim 1, wherein:
providing the supply of water to the gas flow prior to the particular cooling step comprises providing the supply of water within a gas-liquid contact tower, and
collecting the aqueous condensate solution from the gas flow prior to the particular cooling step comprises collecting the aqueous condensate solution from the contact tower.

8. The method of claim 2, wherein providing the supply of the aqueous neutralizing agent comprises providing the aqueous neutralizing agent via an inserted atomizing lance.

9. The method of claim 1, wherein the neutralizing agent is a NaOH solution.

10. The method of claim 1, further comprising communicating a remaining gas flow from the gas flow after providing the supply of water to the particular cooling step.

11. The method of claim 1, wherein the particular cooling step comprises one of:
a gas-gas economizing exchanger,
an air-cooling heat exchanger, or
a refrigeration-based cooling heat exchanger.
